(19) United States
(12) Patent Application Publication
(10) Pub. No.: US 2011/0297270 A1
(43) Pub. Date: Dec. 8, 2011

(54) TECHNIQUE FOR APPLYING PROTECTIVE COVERING TO PIPES AND TUBES

(75) Inventors: Russell O. Brumfield, Cleveland, TN (US); Ronald F. Konopacki, Suffield, CT (US); Kevin E. Taugher, South Hadley, MA (US)

(73) Assignee: ALSTOM TECHNOLOGY LTD, Baden (CH)

(21) Appl. No.: 13/114,435

(22) Filed: May 24, 2011

Related U.S. Application Data
(60) Provisional application No. 61/352,448, filed on Jun. 8, 2010.

(51) Int. Cl. F16L 9/18; F16L 9/14; B23K 31/02

(52) U.S. Cl. 138/142; 228/155; 138/144

(57) ABSTRACT

The manufacture of clad tubes (30) is described. Tube (10) intended to line the walls of a combustion chamber is made of a high strength material to contain the high-pressure steam created. However, these tubes (10) are typically not corrosion/erosion resistant. Manufacture of tubes (10) with both high strength and high resistance to corrosion/erosion would be prohibitively expensive. Therefore, tubes (10) are covered with a non-corrosive material to protect them. This is done by surface welding a strip (20) of high alloy material to the outer surface (12) of the tubes (10). It is preferable to use electric high frequency resistance welding to surface weld the strip (20) onto tube (10). The strips (20) are preferably attached with little melting and metal dilution allowing the strip 20 to keep its corrosion/erosion resistance properties.

### CROSS REFERENCE TO RELATED APPLICATIONS

This application is a continuation-in-part of U.S. Provisional Patent Application 61/352,448 filed Jun. 8, 2010 and therefore incorporates this Provisional Patent Application and claims priority from this application and the benefit of its earlier filing date.

### TECHNICAL FIELD

The present disclosure relates generally to a method for cladding tubes, and more particularly, to a method of wrapping strips of material to outer surface of tubes to clad them.

### BACKGROUND OF THE INVENTION

Steam generation pipes within a boiler are exposed to corrosive and erosive environments that cause the premature failure of pipes and tubes due to wall thinning leading to rupture.

The steam generated typically used in running a turbine for production of electricity and in chemical processes for providing energy to initiate a chemical reaction. Some boilers include one or more walls, each formed of a plurality of tubes, the walls being secured to one another thereby surrounding a combustion chamber within the boiler. Additional groups of tubes can be disposed within the combustion chamber.

Each of the tubes also has an inside surface defining a passage extending therethrough. One end of each of the plurality of tubes can be in fluid communication with a water supply header while an opposing end of each of the plurality of tubes can be in fluid communication with a steam header. During operation of the boiler, combustion generally occurs in the combustion chamber and heats water flowing through the passages, creating steam that is fed to the steam header. The outer surfaces of the tubes in the combustion chamber and throughout the boiler are exposed to fuel, combustion, heat and combustion byproducts that corrode the tubes. As a result, the useful life of the tubes is reduced.

There have been a number of methods employed to add protective coverings to standard pipes and tubes to improve their resistance to increase strength, or to prevent corrosion and erosion. Virtually all of the methods that weld the protective coverings require the covering to be completely melted to adequately attach the covering to the tube.

In conventional welding, a welding rod is melted at its tip. The structure being welded has a trough of material that is also melted. The molten welding rod and the molten surface mix together to create a ‘bead’. The ‘bead’ has a composition that is a mixture of both the molten welding rod and the molten surface. Since a significant amount of welding rod and a significant amount of surface are mixed, there is significant mixing of the metals. Therefore, if the welding rod is made of a high concentration of a high-grade metal and the surface being welded has a lower concentration of the high-grade metal, the resulting mixture (‘bead’) has a lower concentration of the high-grade metal as compared with the original welding rod. This results in the dilution of the concentration of the high-grade metal in the mixed metal bead.

Therefore, as more of the welding rod and more of the surface are melted, more dilution occurs. The diluted metal has less corrosion resistance, erosion resistance and/or less strength.

Therefore, by welding the entire surface of an object, such as tubing, requires a large amount of heat. The large amount of heat may distort the tubing and it is often difficult to control the amount of covering material deposited to optimum thicknesses. This method of cover tubing is difficult to implement.

Typically tubes operating in corrosive or erosive environments are coated, using techniques such as thermal spray or vapor deposition to provide a more protective surface layer. In the most aggressive environments clad tubing produced by co-extrusion has been used. However limitations in the integrity of the bond formed in this way can lead to debonding particularly during long exposures in thermal cycling conditions as a result of the stresses associated with the mismatch in thermal expansion coefficients between the austenitic and ferritic steels.

Currently, there is a need for a method of protecting boiler tubes from erosion and corrosion that may be easily applied without the need for large amounts of energy.

### SUMMARY OF THE INVENTION

In the present invention, a strip of non-corrosive material is applied to the outer surface of the tube to protect tube from corrosion.

The present invention may be embodied as a method for producing clad tubes (30) by:

providing a first tube (10);

providing an elongated strip (20);

surface welding an inner surface (22) of the strip (20) and the outer surface (12) of the tube (10) while helically wrapping the strip (20) around the outer surface (12) of tube (10); and pressing the strip (2) to the tube (10) as it is being surface welded.

### BRIEF DESCRIPTION OF THE DRAWINGS

Referring now to the Figures, which are exemplary embodiments, and wherein the like elements are numbered alike:

FIG. 1 is a perspective view of a strip of material being applied to the outer surface of a tube according to one embodiment of the present invention.

FIG. 2 is a top plan view of the strip of material being applied to the outer surface of a tube of FIG. 1.

FIG. 3 is an elevational view of the strip of material being applied to the outer surface of a tube of FIGS. 1 and 2.

### DETAILED DESCRIPTION OF PREFERRED EMBODIMENTS

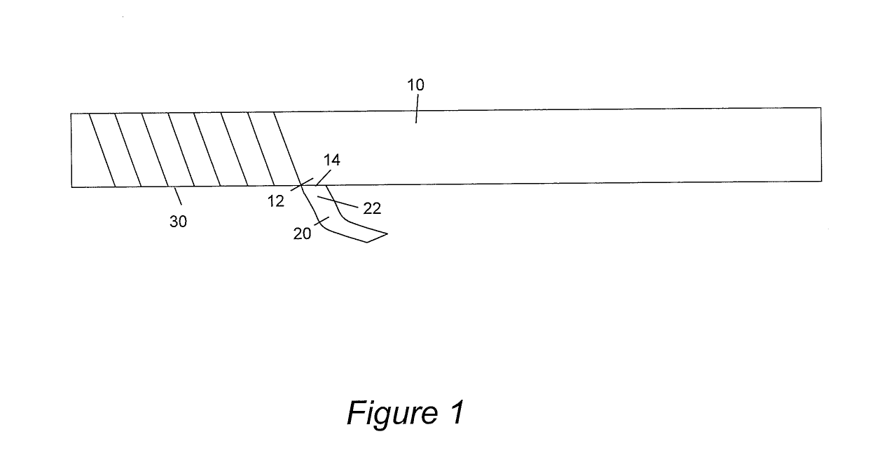

FIG. 1 illustrates a tube 10 less expensive material, such as a low-alloy steel, that is lack properties such as corrosion resistance, erosion resistance or high strength of a that is intended to be used in a boiler. Without protection, corrosion and erosion of the tube 10 reduce the tube wall thickness to a thickness that does not have the strength to retain the pressure of steam within the tubes. When this occurs, they burst. This low-alloy steel tube 10 should be protected to reduce corrosion and erosion, and the thinning of the tube walls.

A strip 20 that is made of a material that exhibits corrosion resistance, erosion resistance, or additional strength is shown here partially wrapped around the outside surface 12 of tube 10. It is preferably wrapped or wound around the tube in a helical fashion while being welded using surface welding techniques creating clad tubing 30.

The strip 20 is manufactured from a suitable corrosion/erosion resistant material that can withstand high temperatures and corrosive environments, such as austenitic steel. While the strip 20 is described as being manufactured from austenitic steel, it is contemplated that the cladding tube can be manufactured from other corrosive-resistant, erosion-resistant, high strength or other cladding materials, depending upon its intended use.

As shown in FIG. 1, it is preferable that the strip 20 be surface welded on its inner surface 22 to the outer surface 12 of tube 10 where they meet ay an interface 14.

One type of electrical resistance weld is a high frequency weld. In this type of weld, a high-frequency alternating current is passed through the strip 20 and the tube 10 setting up a current path. The current flows through the surface of the strip 20 and tube 10 and creates resistive heating in the metal, similar to a toaster heating wire.

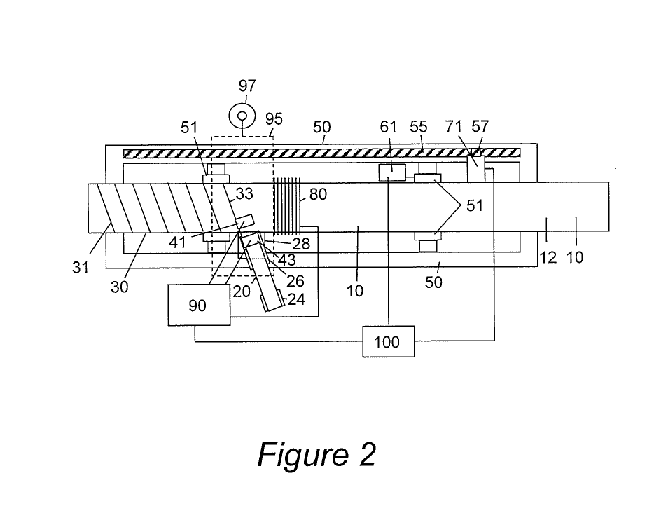

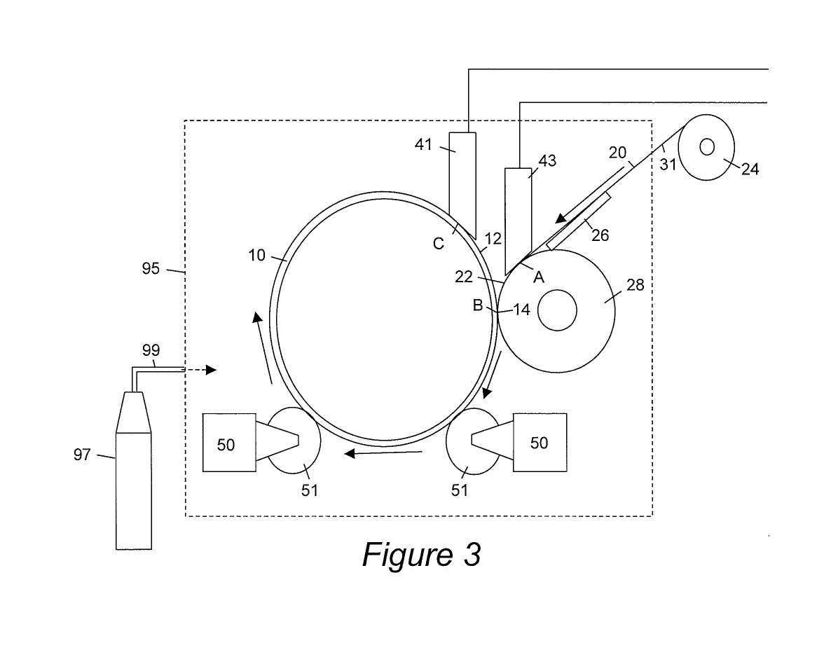

FIG. 2 is a top plan view of the strip 20 of material being applied to the outer surface 12 of a tube 10 of FIG. 1. FIG. 3 is an elevational view of the strip of material being applied to the outer surface of a tube of FIGS. 1 and 2.

With reference to FIGS. 2 and 3, a frame 50 is shown having rollers 51 are used to support the tube 10 as it is being processed. Rollers 51 allow the tube to be rotated. A motor 61 causes rotation of the tube 10. A second motor 71 causes longitudinal motion of the tube 10. Preferably, the motors as well as other aspects of the system activated, coordinated and controlled by the controller 100.

Strip 20 is stored on and provided from a roll 24. A guide 26 is angled with respect to a longitudinal axis of the tube 10. As the tube is rotated by the controller 100 and motors 61, 71, the strip 20 is provided from a supply roll 24 guided by guide 26, pressed against the tube 10 by pressing roller 28 and spirally wound around tube 10.

A contact 41 is coupled to a lead of a welding unit 90 and is positioned to make contact with the strip 20 at a location marked “A” near the location “B” where the strip 20 contacts the pipe 10.

A second contact 43, coupled to a second lead of the high frequency welder unit 90 is positioned to contact the tube 10 at a location marked “C”.

The welding unit 90 is activated and controlled by controller 100. When activated, it causes a surface current to flow between the first contact 41 and the second contact 43. Since there is a large current, even a small inductance in the strip 20 and/or the tube 10 causes significant heat to be created.

The current passes between the surface of strip 20 at location “A”, through the meeting to the tube 10 and strip 20 at location “B” and to the second contact 43 at location “C”.

The current route between A-B-C creates a “V” shape. Due to the nature of surface currents, they converge and concentrate their energy at location “B” where the welding occurs.

Since the heat is provided by a surface current, it is applied evenly at over the inside surface of the strip 20 and the outside surface 12 of the tube 10. The amount of metal melted at both the strip 20 and the tube 10 is very small compared to conventional welding. There is significantly less mixing of the metals and significantly less dilution.

During the surface welding of the present invention, there is substantially less mixing, dilution and the weld is not just in a bead, but also along the inner surface 12 of the strip 10. Therefore, if a high nickel steel is used as strip 10, it will be diluted less by using high frequency welding as compared with conventional welding, and therefore keep more of its corrosion resistant properties. This results in significant cost savings.

This type of weld applies heat only to the region being welded and does not melt the tube and strip material overall. Therefore, there is less warping and distortion of the tube 10 and strip 20 as compared with prior art methods that require melting of the outer protective material, and the corrosion-resistance of the strip alloy is not diluted by mixing with the lower grade alloy of the tube material.

Once the strip 20 and tube 10 are heated, they melt slightly at the surfaces 12, 22. Using high-frequency resistance welding, the surface currents melt only 5-15% of the thickness of the strip 20. It may be about 0.040 inches thick. This is considerably less than the 0.1-0.3 inches that are common to conventional welding of similar geometry and use. A pressing roller 28 presses the strip to the tube 10 thereby causing the molten inner surface 22 of strip 22 to forge to the molten outer surface 12 of pipe 10.

The rotation and longitudinal movement of tube 10 are chosen by controller 100 so that the strip 20 is spirally wrapped onto tube 10. Since the current flows also through the edges 31, 33 of strip 20, the edges also heat up. If the rotation and longitudinal motion of the tube 10 are correctly chosen, the tape will fit flush against the tube 10 and the previous wrapping of the strip 20. Since there is also a concentration of current flow as a first edge 31 of strip 20 meets the second edge 33 near interface 14. This concentration of current also causes the adjacent edges 31, 33 of the spiraled strip 20 to melt and fuse together. Therefore, the strip edges may also be forged together causing one wrap of the strip 20 to bond to the previous wrap of the strip 20.

Preferably, the welding is done an inert atmosphere. Therefore, a source of an inert or non-reactive gas 97, such as neon, argon or xenon passes through an input line 99 into an inert enclosure 95. The inert enclosure encompasses the welding area and seals it to the degree that it can maintain a generally inert atmosphere. This reduces or eliminates the oxidation and other reactions that occur during the welding.

In this embodiment of the present invention, the tube 10 is rotated as the strip 20 is would around its outer surface. It may also be that a device would rotate around the tube 10.

The resulting clad tubing 30 exhibits strength due to the tube 10 being made of a high strength material. The clad tubing 30 also exhibits corrosion resistance due to strip 20 covering tube 10. Tube 30 is significantly lower cost than a tube made entirely of a high-strength, corrosion resistive material.

In an alternative embodiment, the tube 10 may be preheated prior to wrapping the strip 20 onto pipe 10. Many different preheaters may be used, however, an inductively coupled coil 80 is provided in FIG. 2. The coil 80 induces a rapidly changing current in tube 10 that results in resistive heating. The use of the preheating coil 80 increases the effectiveness of the device.

To implement the present invention, it was found that existing tube fin applying machinery might be reconfigured to attach the metal strip 20 to the surface of a tube 10. This results in low start up costs and dual use of existing machinery.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for producing clad tubes comprising:
providing a tube having an outer surface;
providing an elongated strip;
surface welding an inner surface of the strip and the outer surface of the tube while helically wrapping the strip around the outer surface of tube; and
pressing the strip to the tube as it is being surface welded.

2. The method of claim 1, wherein the tube is made of a first metal and the strip is made of a second metal and the surface welding minimizes dilution of the strip with the first metal.

3. The method of claim 1, wherein the inner surface of the strip is welded to the outer surface of the tube as the strip is helically wrapped around the tube.

4. The method of claim 2, wherein the inner surface of the strip is welded to the outer surface of the tube using surface welding techniques as the strip is helically wrapped around the tube.

5. The method of claim 2, wherein the inner surface of the strip is welded to the outer surface of the tube using high frequency surface welding techniques as the strip is helically wrapped around the tube.

6. The method of claim 2, wherein the inner surface of the strip is welded to the outer surface of the tube using surface welding techniques that only melt 5-15% of the thickness of the strip causing minimal dilution of the strip.

7. The method of claim 2, further comprising the step of:
bonding an edge of the strip to an edge of a previous wrapped strip to create a more continuous covering.

8. The method of claim 1, wherein the step of pressing comprises:
pressing strip against tube with a pressing roller.

9. Clad tubing manufactured by the steps of:
providing a first tube having an outer surface;
providing an elongated strip of a corrosion resistive material;
providing a high frequency surface current to the strip and the tube, for melting an inner surface of the strip and the outer surface of the tube, and
helically wrapping the strip around the outer surface of tube while pressing the strip to the tube.

10. The clad tubing of claim 9, wherein the inner surface of the strip is surface welded to the outer surface of the tube as the strip is helically wrapped around the tube.

11. The clad tubing of claim 9, wherein the inner surface of the strip is surface welded using electric resistance welding techniques to the outer surface of the tube as the strip is helically wrapped around the tube.

12. The clad tubing of claim 9, wherein the inner surface of the strip is surface welded using high frequency electric resistance welding techniques to the outer surface of the tube as the strip is helically wrapped around the tube.

13. The clad tubing of claim 9, wherein a first edge of the strip is bonded to a second edge of a previous wrapped portion of the strip.

14. The clad tubing of claim 9, wherein the step of providing a high frequency current to the strip and the tube is performed in a generally inert atmosphere.
